(19) United States
(12) Patent Application Publication
(10) Pub. No.: US 2007/0137119 A1
(43) Pub. Date: Jun. 21, 2007

(54) Plastic window frame covered with aluminum sheet for providing colourable surface

(76) Inventor: Christian Guillemette, Beauport (CA)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/606,361

(22) Filed: Nov. 30, 2006

Related U.S. Application Data
(60) Provisional application No. 60/740,665, filed on Nov. 30, 2005.

(51) Int. Cl. E06B 1/04

(52) U.S. Cl. 52/204.1

(57) ABSTRACT

A prefabricated window structure is disclosed, comprising a sash member having a central area for receiving a glazing, a casing surrounding the sash member. Both the sash member and the casing have a core made of an extruded structural plastic material with an exterior face covered with a cosmetic aluminium sheet.

### FIELD OF THE INVENTION

The present invention relates generally to the field of windows and window frames. More particularly, it concerns a prefabricated window structure made of plastic extrusions covered with a cosmetic aluminium sheet.

### BACKGROUND OF THE INVENTION

Window frames made from extruded plastic, such as polyvinyl chloride (PVC) plastics, have many advantages over equivalent aluminium frames. They are less expensive to produce, and are lighter, which makes them less expensive to ship. In addition, PVC plastics have a much lower thermal conductivity than aluminium and transmit heat at a much lower rate. To compensate for this, aluminium windows must be designed with complex insulation structures so as to limit the heat lost or gained through the window frame and to ensure an efficient heating and cooling of the premises interior.

However, in a world where the demand for coloured window frames is expected to increase importantly in the next couple of years, aluminium frames have one major advantage over PVC frames in that present PVC plastics prove to be quite difficult to coat with a long-lasting paint, or otherwise colour. Presently, a painted PVC frame is expected to last approximately 5 to 10 years. After that time, the frame has to be repainted.

When first introduced in 1987, PVC windows were available in white only. To date, all attempts to colour the raw PVC powder with dark colours have failed. Some pale coloured PVC has become available, but such colours represent few choices and only a small fraction of the market. As a result, PVC window producers have turned to paint manufacturers to develop a long-lasting paint with an improved adhesion to PVC. Despite years of research however, a paint with adequate adhesion to PVC has yet to be developed. While an unpainted PVC window can be guaranteed to 20 years, the paint itself will last only three years. In contrast, a painted aluminium frame can be guaranteed up to 25 years. As a result, the warranties offered for painted PVC windows are far shorter than those for aluminium frames. As demand for an ever-broadening range of styles and colours grows, this discrepancy has proven very costly for manufacturers of PVC windows.

Combinations of aluminium/PVC window frames, dubbed “hybrids”, are known in the art. Hybrid frames comprise an extruded PVC portion and an extruded aluminium portion that have been manufactured separately and assembled prior to installation. Such designs are described in U.S. Pat. Nos. 4,569,154, 4,984,388 and 5,758,458, European Patent No. 0 796 973 Great Britain Patent Nos. 2 073 290 and 2 109 849, and Patent Cooperation Treaty Application No. WO 91/02875. While hybrids combine the advantage of an exterior aluminium face and the thermal insulation properties of PVC, the aluminium component is generally intended for structural support, and as a result these hybrid windows tend to be quite heavy and expensive to produce. In short, they suffer from much the same problems as all-aluminium frames.

Prior to the development of PVC windows, at a time when wooden window frames were still employed, aluminium sheets had been used to cover wooden frames. An example of such a wooden window frame is given in U.S. Pat. No. 4,566,234, issued Jan. 28, 1986 to Held, which describes a wooden window frame with a decorative foil laminate on its exterior and interior surfaces. The foil laminate has a base formed from a plurality of phenol or melamine resin-impregnated paper layers, and a thinly rolled or electrolytically deposited metal foil.

However, such a technique has never been considered for use with PVC windows because of the adverse nature of aluminium and PVC. The attempts that have been made to manufacture aluminium and PVC together in a non-structural way have thus far been unsuccessful. Manufacturers have found that the aluminium dust and particles created in the machining and processing of aluminium, if not carefully monitored and controlled, will contaminate the raw PVC material and damage the final PVC product. Most harmful, however, is the likelihood that airborne aluminium particles may come in contact with PVC extrusion dies. Contact, during operation or otherwise, with metallic particles can seriously damage such dies, which can cost hundreds of thousands of dollars to replace. As a result, there is very little industrial interest in combining the manufacture of windows from PVC and aluminium. In other words, such a combination would not dawn on PVC window frame manufacturers.

Thus, there remains a need for a window frame which takes advantage of properties of PVC plastics, for example their low cost and weight, and the surface qualities of aluminium.

Also known in the art are the following patents and published applications which also describe window frames and the like: U.S. Pat. No. 5,626,958, U.S. Pat. No. 5,972,514, U.S. Pat. No. 6,120,886, U.S. Pat. No. 6,391,143, U.S. 2005/0016673, U.S. 2005/0144865, DE 3938817, DE 40 32 139, JP 11-107627, WO 98/06921.

### SUMMARY OF THE INVENTION

It is an object of the present invention to provide a plastic window frame that satisfies the above-mentioned need.

According to a first aspect, that object is achieved with a prefabricated window structure including a sash member having a central area for receiving a glazing, and a casing surrounding the sash member, in which both the sash member and the casing have a core made of an extruded structural plastic material with an exterior face covered with a cosmetic aluminium sheet.

As can be appreciated, and thanks to the cosmetic aluminium sheet which covers the exterior face of the window core, a prefabricated window structure according to the present invention can advantageously make the maximum of the lower cost, weight and thermal conductivity of a PVC core, with the durability and colourability of a cosmetic aluminium covering. Furthermore, the present invention is adaptable to presently available window models, which is a substantial savings for manufacturers and, therefore, consumers.

Preferably, both the sash member and the casing are composed of a pair of vertical rails and a pair of horizontal rails having inner and outer longitudinal side edges. For a sake of clarity, it is worth mentioning that throughout the following description the inner and outer sides are defined relative to the central area of the window whereas the interior side or face and exterior side or face of the window are defined relative to the interior and the exterior of the building embodying the window structure. The exterior face will also be referred as to the front face of the window and the interior face will also be referred as the back face of the window.

In accordance with a first preferred variant, the aluminium sheet has longitudinal side edges connected along the inner and/or outer side edges of the vertical and horizontal rails. In such a case, the longitudinal side edges of the aluminium sheet embrace at least a portion of the respective inner and outer side edges of the vertical and horizontal rails. In other words, the side edges of the aluminium sheet are wrapped around the side edges of the rails so as to contour the shape of the same.

Preferably, the portion of the inner longitudinal side edges of the sash member comprises an interior face provided with a resilient glazing seal, the longitudinal side edge of the aluminium sheet embracing said portion being pinched between the interior face and the glazing.

In accordance with another variant, the inner and/or outer side edges of the vertical and horizontal rails comprise a longitudinal channel, in which a portion of the side edge of the aluminium sheet is forced and frictionally retained. More preferably, the channel has an open end with a reduced cross-section thereby increasing the retention of the portion of the aluminium sheet forced therein.

Alternatively, the aluminium sheet can be secured to the rails with fasteners selected from the group consisting of screws, clips, nails, staples or with double-sided tapes provided between the aluminium sheet and the surface of the rails.

In accordance with a further preferred embodiment of the invention, the window structure includes at least one mullion for dividing glazings of the window structure. The mullion has a flange projecting out of an exterior wall of the mullion, the flange being covered with an aluminium sheet. More preferably, the aluminium sheet is glued to the flange.

According to a second aspect, that object is also achieved by a method of colouring a window structure made of an extruded structural plastic material, including the steps of: a) providing a window structure having vertical and horizontal rails made of an extruded structural plastic material, each of said rails having an interior face opposite to an exterior face; and b) covering the exterior face of each of said rails with a cosmetic aluminium sheet.

Preferably, the method can include a step of cutting the aluminium sheet to an appropriate size to fit a desired portion of the exterior face prior to step b), a step of roll forming the aluminium sheet to fit a portion of the plastic window structure prior to step b), or a step of colouring the aluminium sheet prior to step b).

### BRIEF DESCRIPTION OF THE DRAWINGS

These and other objects and advantages of the invention will become apparent upon reading the detailed description and upon referring to the drawings in which:

FIG. 1 is a simplified perspective representation of a window in an open position according to a preferred embodiment of the present invention.

FIG. 2 is a detailed view of a cross-section taken along line II-II in FIG. 1 with the window in a closed position.

FIG. 3 is a detailed view of a cross-section taken along line II-II in FIG. 1 of the window sill, showing a variant connection between the aluminium sheet and the casing.

FIG. 4 is a cross-section of a mullion with its exterior side covered with an aluminium sheet.

FIG. 5 is a perspective view of a portion of the window of FIG. 1 showing the left jamb of the casing and the left stile of the sash in cross-section taken along line V-V.

While the invention will be described in conjunction with example embodiments, it will be understood that it is not intended to limit the scope of the invention to such embodiments. On the contrary, it is intended to cover all alternatives, modifications and equivalents as may be included as defined by the appended claims.

### DESCRIPTION OF THE PREFERRED EMBODIMENTS

In the following description, similar features in the drawings have been given similar reference numerals and in order to lighten the figures, some elements are not referred to in some figures if they were already identified in a precedent figure.

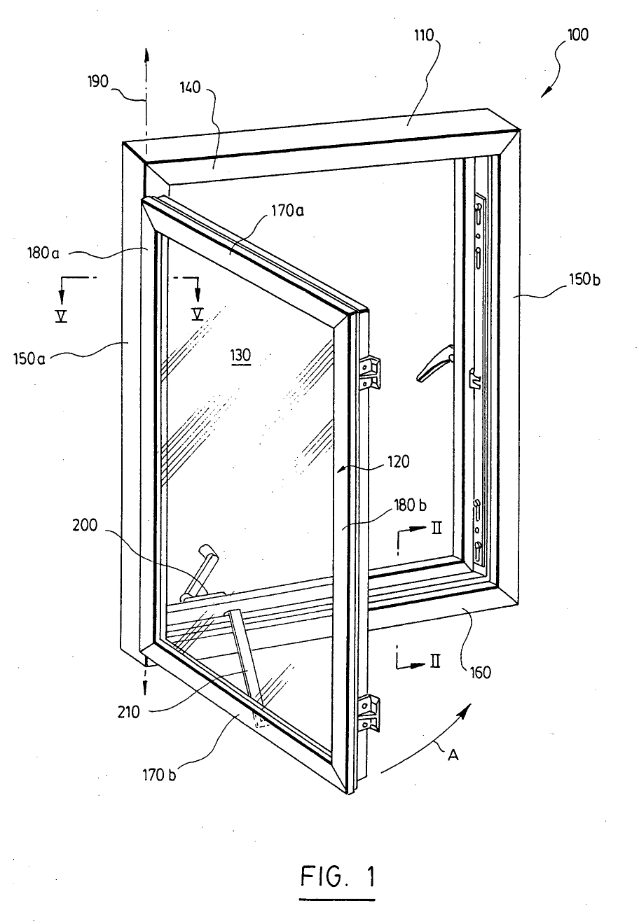

In FIG. 1, a prefabricated window structure 100 is illustrated comprising a casing 110, a sash member 120 and a transparent pane in a central area thereof, such as glazing 130. The casing 110 is installed in a building wall (not shown). The casing 110 and sash 120 each comprise a core made of an extruded structural plastic, such as PVC. These cores are each generally formed from a set of horizontal and vertical extruded PVC rails 140, 150, 160, 170 and 180, as is known in the art. More specifically, the casing 110 is formed of a header 140, first and second jambs 150a,b and a sill 160 which combined form the top, left, right and bottom portions, respectively, of the window casing 110. The upper and lower rails 170a,b and the first and second stiles 180a,b form the top, bottom, left and right sides of the sash 120 and collectively retain the glazing 130 in the central area of the window 100.

In this case, the window 100 is a casement window openable to the exterior via the pivoting engagement between the sash 120 and the casing 110 along a generally vertical axis 190, located between the first jamb 150a and the first stile 180a. The casement window 100 is opened and closed with the use of a hand crank mechanism 200, which controls a positioning arm 210. Such opening and closing mechanisms are well known in the art and will not be discussed further here. It is to be understood, however, that the present invention can be used with any number of windows types, including but not limited to awning, sliding, French, louvered, double hung, picture and bay windows, which may open, close or remain fixed in different manners, or similarly constructed doors. In addition, the present invention is equally applicable to fixed windows wherein the casing 110 and sash 120 are integral.

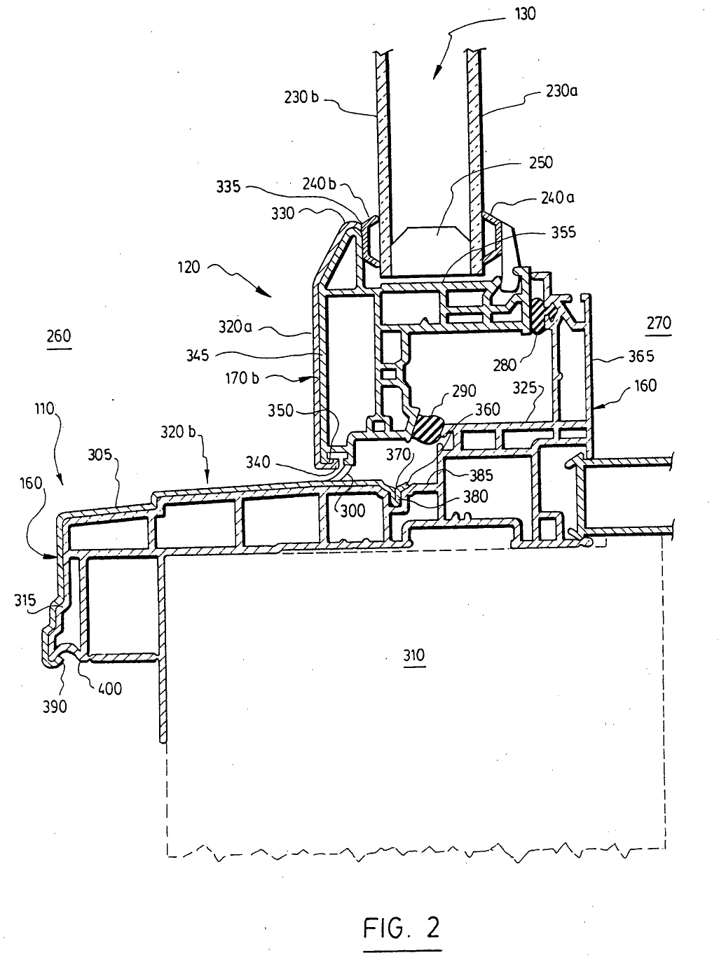

In FIG. 2, a cross section of the window 100 as installed in a wall 310 and in a closed position is illustrated. The cross-section taken along line II-II of FIG. 1 depicts the relationship between the sash 120 and the casing 110 by illustrating in greater detail the bottom edge of the window 100 (i.e. the sill 160 and the lower rail 170b). The glazing 130 preferably comprises two glass panes 230a,b separated by a spacer 250. The glazing 130 is sandwiched in place by a pair of resilient seals 240a,b. The glazing 130 generally divides the window structure 100 into an exterior side or front side 260 which faces the exterior of the building and an interior side of rear side 270 which faces the interior of the building.

On the exterior side 260, the sill 160 comprises a ledge 305 which extends horizontally outward from the window structure 100, and a downwardly extending lip 315 which cups the wall 310 at the frontmost edge of the ledge 305. On the interior side 270, the sill comprises a platform 325 which is substantially parallel to, and vertically higher than, the ledge 305. A vertical backface 365 extends vertically upwards from the interior side of the platform 325. The rail 170b of the sash 120 comprises a front panel 345 and a horizontal panel 355 on which the glazing 130 is installed. The front panel 345 extends substantially parallel to the vertical backface 365 of the sill 160 just described.

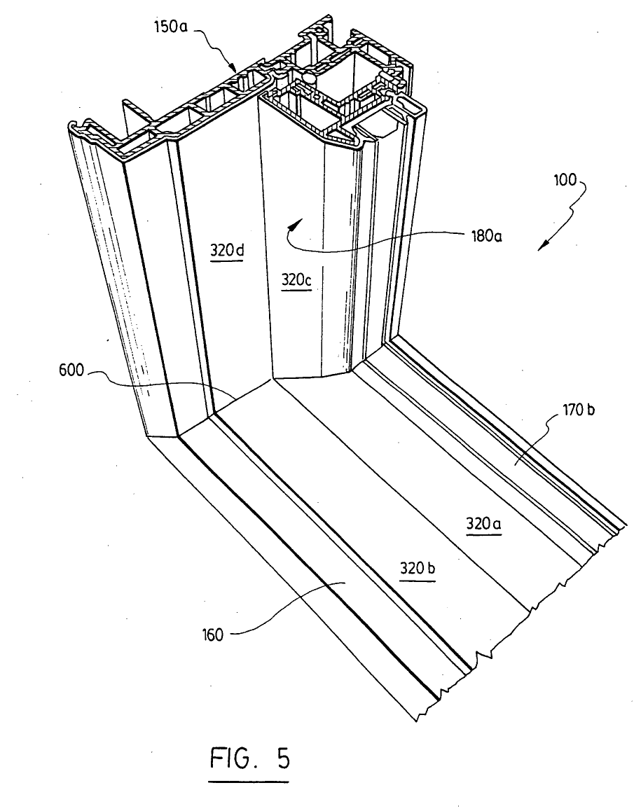

As seen for example in FIG. 5, the cross-section shown in FIG. 2 is analogous to cross-sections of the side and top edges (i.e. the first jamb 150a and the first stile 180a; the second jamb 150b and the second stile 180b; the header 140 and the top rail 170a), which will therefore not be discussed in detail.

When the window 100 is closed, the sash 120 and the casing 110 are sealed by the weather-stripping 280, 290 and 300. The weather-strippings can come in various forms, but are generally made of a resilient rubber material so that they deform when pressed between two surfaces. The weather-stripping 280 and 290 are of a hollow tubular form and the weather-stripping 300 is of a blade form. The weather-stripping 280 is attached to the sill 160, while the weather-stripping 290 and 300 are attached to the lower rail 170b.

Turning back to FIG. 2, in the embodiment illustrated herein, the ledge 305 extends under the rail 170b and is operable to sealingly engage the blade form weather-stripping 300 which extends downwardly from the bottom of the front face 345. The weather-stripping 280 is retained along the upper end of the backface 365 and is operable to seal against the interior edge of the horizontal plate 355. The weather stripping 290 is retained to the interior bottom edge of the front panel 345 and is operable to seal against the exterior edge of the platform 325.

As noted, the above described engagement of the sill 160 and the lower rail 170b is typical of the remaining three sides of the window structure 100 and will not further be discussed herein. Moreover, is it to be noted that the specific construction of sill 160 and the lower rail 170b discussed hereinabove is included for illustrative purposes only and is not to be considered limiting. As will be apparent to one of ordinary skill in the art, the present invention is applicable to numerous other specific constructions of the window structure 100 composed of rails having a core made of extruded structural plastic material.

On the exterior side 260 of the window 100 are provided two thin sheets of aluminium sheet 320a and 320b which cover the exterior of the sash 120 and the casing 110, respectively. The aluminium sheets 320a and 320b are formed to contour the shape of the exterior sides of the sash 120 and the casing 110. The header 140, jambs 150a,b, and sill 160 may all have similar contours and thus the respective aluminium sheets 320a which cover each may be formed to the same shape and cut to varying lengths as needed. Similarly, the rails 170a,b and stiles 180a,b may be formed in the same shape and require similar sheets 320b. However, for more complex window structures 100, differently formed sheets 320 may be required to properly contour all the rails of a given window structure 100. Combined, the aluminium sheets 320a,b cover an exposed portion of the PVC window 100, thereby protecting the PVC from the exterior elements and providing a surface which can be easily painted and maintained.

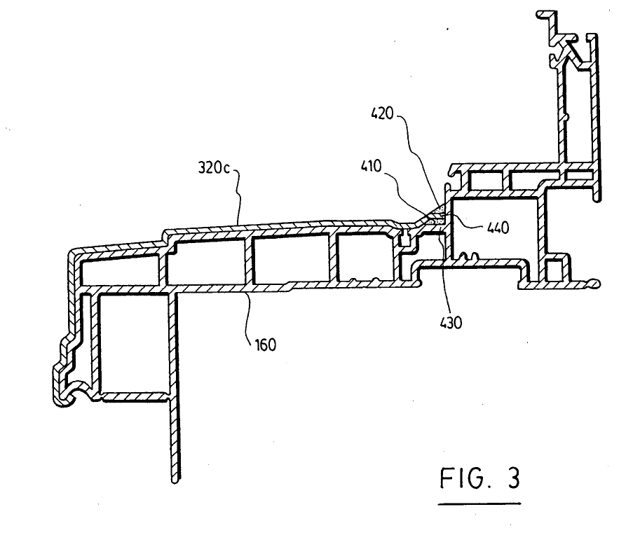

In one embodiment, the aluminium sheet 320a is attached to the lower rail 170b by embracing the inner and outer longitudinal side edges 330, 340 thereof around the inner and outer side edges 335, 350, respectively, of the rails of the sash member 120 so as to contour the shape of the same. More preferably, the inner longitudinal side edge 330 of the sheet 320 is positioned between an interior face of the front panel 345 and the seal 240b, which is resilient in nature. With the glass panes 230a,b installed, the sheet 320 is held in place as its side edge 330 is pinched between the interior face of the front panel 345 and the glazing 130 via the seal 240b. On its side, the outer side edge 340 of the aluminium sheet 320a is glued in place along the outer side edge 350 of the lower rail 170b. In that particular case, both the inner and outer side edges 330, 340 of the aluminium sheet 320a are formed to embrace at least a portion of the inner and outer side edges 335 and 350 of the lower rail 170b, cupping around the contours of the edges so as to further retain the sheet 320a. One side edge 360 of the aluminium sheet 320b is preferably fastened to the sill 160 at a midsection 385 joining the platform 325 and the ledge 305, and which extends below the lower rail 170b. That side edge 360 is attached to the sill either by snapping a fold 370 thereof into a longitudinal channel or groove 380 provided in the midsection 385 of the sill, as in FIG. 2, or by gluing that side edge 360 along the midsection 385, as in FIG. 3. Using the “snap-in” method, a section of the sheet 320b is forced into the channel 380 such that the fold 370 is formed inside channel but that the side edge 360 remains outside. In this manner, the fold 370 is pinched at the mouth of the channel 380. Preferably, the channel 380 is positioned along the mid section 385 between the weather stripping 300 and the platform 325 such that the sheet 320b covers at least the portion of the lower rail 170b which is exposed to the elements when the window 100 is closed. Similarly, this construction ensures that the fold 370 and the insertion section 380 themselves are not exposed to the outside when the window structure 100 is closed.

As mentioned above, the side edge 360 can alternatively glued the midsection 385, as in FIG. 3. In such a case, a double-sided tape 410 and a sealant 420 are preferably used. A thin strip of double-sided tape 410 is placed along the mid section 385 of sill 160, proximate the channel 380 used in the previous embodiment. On top of the tape 410 is placed the side edge 360 of the sheet 320b, which is in turn covered by a strip of sealant 420 to block moisture from getting between the casing 110 and the aluminium sheet 320c. The sealant 420 can be of a number of types of sealant including, but not limited to, hot-melt sealants and butyl rubber. Because it is gas impervious, butyl rubber is a preferred choice for the sealant 420.

Referring to either one of FIG. 2 and 3, the other side edge 390 of the aluminium sheet 320b is glued in place along the outer longitudinal side edge 400 of the sill 160, similarly to the outer edge 340 of the aluminium sheet 320a covering the sash member 170b. Further attachment methods can be of a number of forms including, but not limited to, screws, clips, nails and staples.

In short, three preferred different methods of attaching an aluminium sheet to a portion of the casing 110 and sash 120 of a PVC window are considered in FIGS. 2 and 3: first by pinching the edge 330 of sheet 320a between the seal 240b and the lower rail 170b; second by “snap-in” (i.e. creating a fold 370 pinched in the sill 160 by forcing a portion of sheet 320b into a channel 380); and third by simply gluing the edges 360, 390 along the mid section 385 of sill 160 or lip 315 respectively. With reference to the previous embodiment, FIG. 3 illustrates more clearly a preferred version of the channel 380. In that case, the open end of the channel 380 has a reduced cross-section 375, i.e. the opening of the channel 380 is less than the width of the channel 380 itself, such that the fold 370 can spread out within the channel 380, thereby further securing it therein.

As will be apparent to one of ordinary skill in the art, the sealants described above are commonly used in conjunction with conventional window constructions for preventing moisture infiltration. While the use of the sealant 240 is particularly preferable when using double-sided tape to secure aluminium sheet to a PVC casing or sash, it is to be noted that the application of a sealant may be advantageously employed in conjunction with any of the other methods of attaching the sheet 320

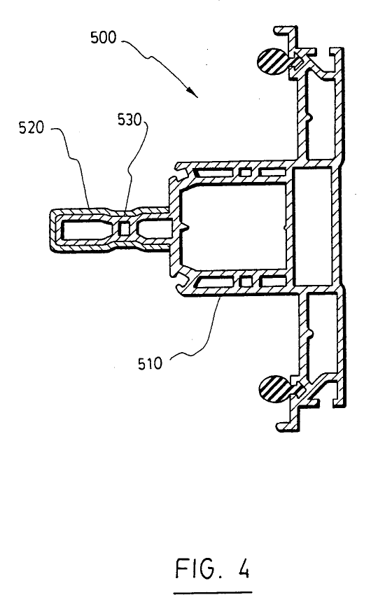

FIG. 4 illustrates a mullion 500, sometimes known as a muntin, of a window which might divides the glazing of the window structure 100. The mullion frame has an exterior wall 510 partially covered with an aluminium sheet 520. As illustrated herein, it is only the flange 530 which is covered with the sheet 520 since it is this portion which is exposed when the mullion 500 is installed with corresponding sashes (not shown). As will be apparent to one of ordinary skill in the art, embodiments in which the sheet 520 covers more, or less, of the mullion 500 are well within the scope of the present invention. It will be further apparent to one of ordinary skill in the art that the illustration of mullion 500 is analogous to the cross-section of a transom (not shown) and is therefore fully applicable to the present invention.

The thickness of the aluminium sheets 320a,b; 520 are preferably in the range of 0.014 to 0.032 inches, making them thicker and more durable than conventional aluminium foil, but malleable enough to conform easily to the contours of the extruded PVC casing 110 and sash 120. Not only would covering the exterior of PVC frames with such aluminium sheets be roughly half the price of painting them, but the aluminium sheets can be applied to existing PVC window frame models. As such, the creation of new extrusion moulds, whose costs can reach the millions of dollars, is not required.

In use, the aluminium sheets 320 are preferably roll-formed to mimic the contours of the casing 110 and sash 120, and applied to thereto prior to installation. The aluminium sheets are provided coloured and cut to the appropriate size to fit each specific frame. In addition, if the aluminium sheet is to be “snapped-in” to the casing 110 or sash 120 by, as described above, the location of each insertion section 380 can be indicated on the aluminium sheet with ink, a different paint, or by physically deforming or scoring the aluminium sheet. This would allow an individual installing the window to see easily where to create the fold 370 in the insertion section 380.

In use, the window structure 100 is preferably coloured by first roll forming a thin aluminium sheet to an appropriate cross-sectional shape and cutting the sheet to fit a given window construction. The cut and formed aluminium is then preferably painted to a desired colour. The header 140, the jambs 150a,b and the sill 160 are provided to form the casing 110, as well as the upper and lower rails 170a,b and stiles 180a,b to form the sash 120. The exterior faces of each of these elements are then at least partially covered with the thin sheet of aluminium 320, and retained thereto.

FIG. 5 illustrates a perspective view of a portion of the prefabricated window structure 100 showing the first jamb 150a and first stile 180a in cross-section. As noted above, this cross-section is substantially equivalent to that shown in FIG. 2.

In addition to the sheets 320a and 320b covering the lower rail 170b and the sill 160, respectively, two sheets 320c and 320d are shown covering the first stile 180a and the first jamb 150a, respectively. The horizontal members 160 and 170b meet the vertical members 150 and 180a along an intersection 600.

In order to prevent unwanted moisture from infiltrating the window 100 and seeping through the joint 600, between the aluminium sheets 320 and PVC frame, the lower aluminium sheets 320a and 320b are cut such that their lateral edges extend beyond the joint 600. As such, the lower, horizontally extending sheets 320a and 320b extend between the PVC members and the vertically extending sheets 320a and 32b, respectively. In this manner, the likelihood of water infiltration is greatly decreased as, for example, rain travels down the window 100.

This overlapping of the sheets 320 is also applicable to the upper the joints. In this case, however, it is the horizontally extending header 140 and upper rail 170a which overlaps the vertically extending jambs 150 and stiles 180.

As will be apparent to one of ordinary skill in the art, a sealant can be applied along any joints 600, in conjunction with the overlapping arrangement of the aluminium sheets 320.

The above description of a preferred embodiment of the present invention should not be read in a limitative manner as refinements and variations are possible without departing from the spirit of the invention. The scope of the invention is defined in the appended claims and their equivalents.

1) A prefabricated window structure, comprising:
a sash member having a central area for receiving a glazing;
a casing surrounding the sash member, and wherein both the sash member and the casing have a core made of an extruded structural plastic material with an exterior face covered with a cosmetic aluminium sheet.

2) The window structure of claim 1, wherein the sash member is composed of a pair of vertical rails and a pair of horizontal rails having inner and outer longitudinal side edges, the inner and outer sides being defined relative to the central area, and wherein the aluminium sheet has longitudinal side edges connected along the inner and outer side edges of the vertical and horizontal rails of the sash member.

3) The window structure of claim 2, wherein said longitudinal side edges of the aluminium sheet are embracing at least a portion of the inner and outer side edges of the vertical and horizontal rails of the sash member.

4) The window structure of claim 3, wherein said portion of the inner longitudinal side edges of the sash member comprises an interior face provided with a resilient glazing seal, the longitudinal side edge of the aluminium sheet embracing said portion being pinched between the interior face and the glazing.

5) The window structure of claim 2, wherein at least one of the inner and outer side edges of the vertical and horizontal rails comprises a longitudinal channel, and wherein a portion of the side edge of the aluminium sheet is forced in the channel and frictionally retained therein.

6) The window structure of claim 5, wherein the channel has an open end with a reduced cross-section thereby increasing the retention of the portion of the aluminium sheet forced therein.

7) The window structure of claim 6, wherein a sealant is provided along the longitudinal side edges of the aluminium sheet and the side edges of the sash member for preventing moisture infiltration.

8) The window structure of claim 1, wherein the casing is composed of a pair of vertical rails and a pair of horizontal rails having an exterior and an interior longitudinal side edges and a mid section between the exterior and interior side edges, and wherein the aluminium sheet has longitudinal side edges connected along the exterior side edges and mid section of the vertical and horizontal rails of the casing.

9) The window structure of claim 8, wherein at least one of the exterior side edge and mid section of the vertical and horizontal rails comprises a longitudinal channel, and wherein a portion of the side edge of the aluminium sheet is forced in the channel and frictionally retained therein.

10) The window structure of claim 9, wherein the channel has an open end with a reduced cross-section thereby increasing the retention of the portion of the aluminium sheet forced therein.

11) The window structure of claim 2, comprising fasteners selected from the group consisting of screws, clips, nails, staples and glues to connect the aluminium sheets to the vertical and horizontal rails.

12) The window structure of claim 10, wherein a sealant is provided along the longitudinal side edges of the aluminium sheet and the side edges and mid section of the casing for preventing moisture infiltration.

13) The window structure of claim 8, comprising a double-sided tape provided between the aluminium sheet and at least a portion of the mid section of the vertical and horizontal rails of the casing.

14) The window structure of claim 1, wherein the aluminium sheet is roll-formed to fit the plastic core of the sash member and casing.

15) The window structure of claim 1, wherein the aluminium sheet has a thickness between 0.014 inches and 0.032 inches.

16) The window structure of claim 1, further comprising at least one mullion for dividing glazings of the window structure, the mullion having a flange projecting out of an exterior wall of the mullion, the flange being covered with an aluminium sheet.

17) The window structure of claim 16, wherein the aluminium sheet is glued to the flange.

18) The window structure of claim 2, wherein the casing is composed of a pair of vertical rails and a pair of horizontal rails and wherein the pair of horizontal rails of both the sash member and the casing comprise upper and lower rails, wherein the aluminium sheet has transversal side edges, wherein the transversal side edges of the aluminium sheet covering the upper horizontal rail overlaps the transversal side edges of the aluminium sheet covering the vertical rails, and wherein the transversal side edges of the aluminium sheet covering the vertical rails overlaps the aluminium sheet covering the lower horizontal rail.

19) A method of colouring a window structure made of an extruded structural plastic material, comprising the steps of:
providing a window structure comprising vertical and horizontal rails made of an extruded structural plastic material, each of said rails having an interior face opposite to an exterior face; and
covering the exterior face of each of said rails with a cosmetic aluminium sheet.

20) The method of claim 19 comprising prior to step b) a step of cutting the aluminium sheet to an appropriate size to fit a desired portion of the exterior face.

21) The method of claim 19 comprising, prior to step b), a step of roll forming the aluminium sheet to fit a portion of the plastic window structure.

22) The method of claim 19 comprising, prior to step b),a step of colouring the aluminium sheet.
